(19) United States
(12) Patent Application Publication
(10) Pub. No.: US 2020/0174307 A1
(43) Pub. Date: Jun. 4, 2020

(54) LIQUID CRYSTAL DISPLAY DEVICE HAVING HIGH SCREEN RATIO

(71) Applicant: HON HAI PRECISION INDUSTRY CO., LTD., New Taipei (TW)

(72) Inventor: KUO-CHOU CHANG, New Taipei (TW)

(21) Appl. No.: 16/687,984

(22) Filed: Nov. 19, 2019

Related U.S. Application Data
(60) Provisional application No. 62/774,344, filed on Dec. 3, 2018.

(51) Int. Cl. G02F 1/1333; G02F 1/1362; G02F 1/1335

(52) U.S. Cl. CPC G02F 1/133308; G02F 1/1362; G02F 1/133528; G02F 2001/136222; G02F 1/133514; G02F 2001/133317; G02F 1/133512

(57) ABSTRACT

An LCD device with camera includes a backlight module and an LCD panel. The LCD panel includes a color filter substrate, a thin film transistor (TFT) substrate, a liquid crystal layer between the color filter substrate and the TFT substrate, and a lower polarizer on a side of the TFT substrate away from the liquid crystal layer. The lower polarizer is adjacent to the backlight module. The backlight module defines a hole for camera. The camera hole extends through the lower polarizer. The camera hole includes a bottom wall and a sidewall coupling to the bottom wall. The bottom wall is defined and formed by the TFT substrate. An adhesive layer in a coupling region of the bottom wall and the sidewall blocks leakage of light from the backlight module.

### FIELD

The subject matter herein generally relates to a liquid crystal display (LCD) devices, particularly relates to a full-screen LCD device having a high screen ratio.

### BACKGROUND

A conventional LCD device generally includes an LCD panel and a backlight module. Taking mobile phones as an example, full-screen mobile phones having high screen ratio are becoming more and more popular. The high screen ratio requires increasing a screen ratio and reducing sizes of frames to give consumers a better visual experience.

### BRIEF DESCRIPTION OF THE DRAWINGS

Implementations of the present technology will now be described, by way of embodiments only, with reference to the attached figures.

FIG. 1 is an isometric view of an LCD device in accordance with an embodiment of the present disclosure.

FIG. 2 is a cross-sectional view taken along line II-II of FIG. 1.

FIG. 3 is an enlarged view showing a portion III of FIG. 2.

FIG. 4 is a bottom view of a part of the LCD device of FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

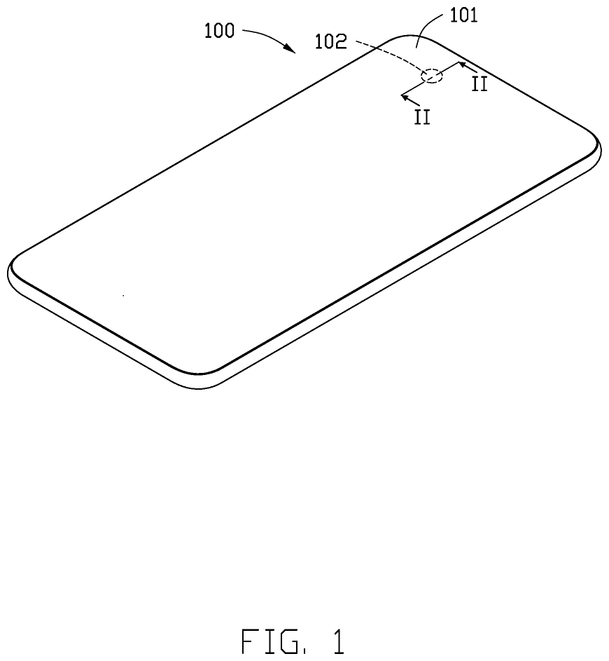

FIG. 1 illustrates an LCD device 100 according to an embodiment. The LCD device 100 defines a display area 101. In this embodiment, the LCD device 100 is a full-screen mobile phone and display area 101 occupies entire front surface of the LCD device 100. A camera area 102 is positioned in the display area 101. The camera area 102 is a non-display area. In this embodiment, the camera area 102 is circular.

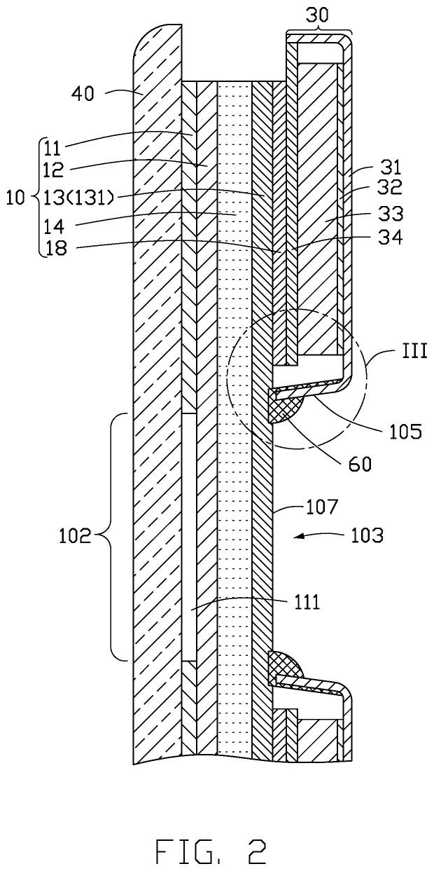

As shown in FIG. 2, the LCD device 100 includes a transparent cover 40, an LCD panel 10, and a backlight module 30. The LCD panel 10 is between the transparent cover 40 and the backlight module 30. A camera hole 103 is defined in the backlight module 30 and aligned with the camera area 102. A camera module (not shown) is positioned in the camera hole 103. A portion of the LCD panel 10 aligning with the camera area 102 allows light to pass through so as not to affect camera function of the camera module. For example, the portion of the LCD panel 10 aligning with the camera area 102 is transparent. In addition, housing for accommodating the LCD panel 10 and the backlight module 30 in the LCD device 100 is omitted in FIG. 2.

The LCD panel 10 is a conventional LCD panel and includes a color filter substrate 12, a thin film transistor (TFT) substrate 13 opposite to the color filter substrate 12, and a liquid crystal layer 14 between the color filter substrate 12 and the TFT substrate 13. The LCD panel 10 further includes an upper polarizer 11 and a lower polarizer 18, wherein the upper polarizer 11 is laminated on a side of the color filter substrate 12 away from the liquid crystal layer 14; and the lower polarizer 18 is laminated on a side of the TFT substrate 13 away from the liquid crystal layer 14. The transparent cover 40 is adjacent to the upper polarizer 11, and the lower polarizer 18 is adjacent to the backlight module 30. The TFT substrate 13 includes a transparent substrate 131 and a plurality of conductive components (not shown) on the transparent substrate 131. The conductive components may be TFTs, data lines, scanning lines, and the like. The color filter substrate 12 includes a transparent substrate (not shown) and a color filter layer (not shown) on the transparent substrate.

In order not to affect the camera function of the camera module, a portion of the color filter substrate 12 aligning with the camera area 102 and a portion of the TFT substrate 13 aligning with the camera area 102 are transparent. Since both the upper polarizer 11 and the lower polarizer 18 are opaque, the upper polarizer 11 defines a through hole 111 extending through the upper polarizer 11, and the camera hole 103 also extends through the lower polarizer 18, as shown in FIG. 2. The through hole 111 is aligned with the camera area 102. That is, the hole in the lower polarizer 18 and the hole in the backlight module 30 are aligned with each other and form the camera holes 103.

As shown in FIG. 2, the backlight module 30 is a side-type backlight module conventionally used in the art and includes a back plate 31 to carry optical components of the backlight module 30. The optical components include a reflection sheet 32 stacked on the back plate 31, a light guide plate 33 stacked on the reflection sheet 32, an optical film group 34 stacked on the light guide plate 33, wherein the optical film group 34 is relatively adjacent to the LCD panel 10. Specifically, the optical film group 34 of the backlight module 30 is coupled to the lower polarizer 18 of the LCD panel 10. The backlight module 30 further includes a light source (not shown) positioned on a side of the light guide plate 33. The optical film group 34 includes a diffusion sheet (not shown), and a brightness enhancement film (not shown).

As shown in FIG. 2, each of the reflection sheet 32, the light guide plate 33, and the optical film group 34 is substantially a flat plate. The camera hole 103 extends through the reflection sheet 32, the light guide plate 33, and the optical film group 34. A main structure of the back plate 31 is a flat plate on a side of the reflection sheet 32 away from the LCD panel 10, and the back plate 31 bends at a position of the camera area 102 to extend toward the LCD panel 10 until reaching the transparent substrate 131 of TFT substrate 13 such that a portion of the back plate 31 defines a sidewall 105 of the camera hole 103. A portion of the transparent substrate 131 aligning with the camera area 102 defines a bottom wall 107 of the camera hole 103.

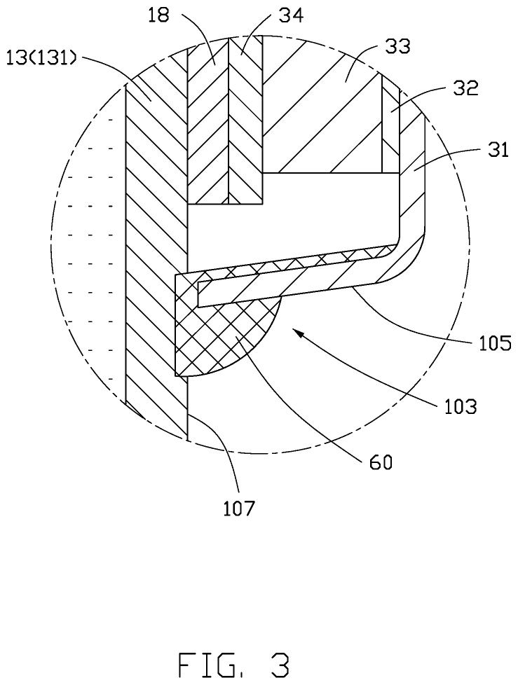

As shown in FIG. 2 and FIG. 3, in this embodiment, the back plate 31 is not in direct contact with the transparent substrate 131 of the TFT substrate 13. An end of the back plate 31 adjacent to the transparent substrate 131 is spaced from the transparent substrate 131. It can be understood that in other embodiments, an end of the back plate 31 adjacent to the transparent substrate 131 is in direct contact with the transparent substrate 131.

Since the camera hole 103 is positioned in the display area 101, and there may be gap in assembly of the backlight module 30 and the LCD panel 10, light from the backlight module 30 is easily leaked to the outside. For example, light from the backlight module 30 can pass through a gap between the back plate 31 and the transparent substrate 131 and leak through the transparent substrate 131 or directly leak through the transparent substrate 131 (light leakage on the front side); light may also leak through a gap between the back plate 31 and the transparent substrate 131 toward the backlight module 30 (light leakage on the back side). A coupling region of the back plate 31 and the transparent substrate 131 is therefore provided with an adhesive layer 50. That is, a coupling region of the sidewall 105 and the bottom wall 107 of the camera hole 103 is provided with an adhesive layer 50. The adhesive layer 50 partially covers the transparent substrate 131 and the back plate 31.

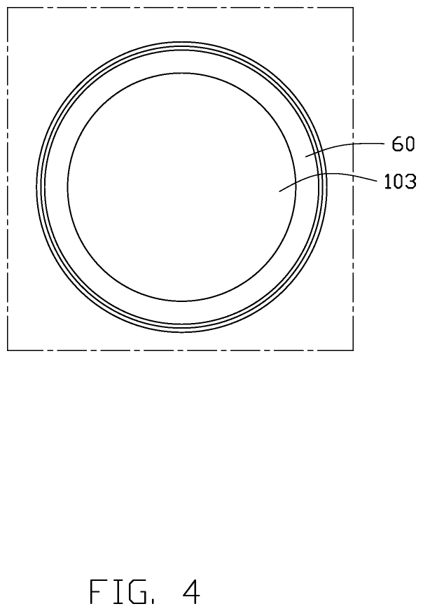

As shown in FIG. 4, the adhesive layer 50 is ring-shaped and extends along a peripheral portion of the bottom wall 107 of the camera hole 103, blocking leakage of light. The adhesive layer 50 may employ various conventional adhesives, such as hot melt adhesives; the adhesive layer 50 may have a black or other color having a light-blocking ability. The adhesive layer 50 can fill a gap between the back plate 31 and the transparent substrate 131, which makes a bonding of the back plate 31 and the transparent substrate 131 more stable.

In additional, a light shielding layer 60 is positioned on a surface of the transparent substrate 131 adjacent to the backlight module 30. The light shielding layer 60 extends around a circumference of the bottom wall 107 of the camera hole 103 to form a ring shape, thereby further preventing light leakage. In this embodiment, the light shielding layer 60 completely shields the adhesive layer 50. A projection of the light shielding layer 60 along a normal direction of the transparent substrate 131 on the transparent substrate 131 completely covers a projection of the adhesive layer 50 along a normal direction of the transparent substrate 131 on the transparent substrate 131. As shown in FIG. 2, the light shielding layer 60 extends beyond the bottom wall 107 of the camera hole 103 on the surface of the transparent substrate 131 facing the backlight module 30 to further effectively prevent light leakage. The adhesive layer 50 directly and partially covers the light shielding layer 60.

The light shielding layer 60 may be formed on the transparent substrate 131 by spraying, printing, or other conventional manner. The light shielding layer 60 is made of a material having a light blocking capability.

When assembling the LCD device 100, the light shielding layer 60 is formed as a preliminary step on the transparent substrate 131, and the lower polarizer 18 defining a through hole is attached to the transparent substrate 131, which can prevent light leakage caused by a tolerance of the through hole in the lower polarizer 18 and an assembly tolerance of the lower polarizer 18 attaching to the transparent substrate 131.

When assembling the LCD device 100, the LCD panel 10 and the backlight module 30 are separately assembled in advance, and after the adhesive layer 50 is formed on the back plate 31 of the backlight module 30, the light shielding layer 60 is formed on the transparent substrate 131, then the LCD panel 10 and the backlight module 30 are assembled and bonded together, thereby preventing light leakage caused by any gap at all between the backlight module 30 and the LCD panel 10.

Even though information and advantages of the present embodiments have been set forth in the foregoing description, together with details of the structures and functions of the present embodiments, the disclosure is illustrative only. Changes may be made in detail, especially in matters of shape, size, and arrangement of parts within the principles of the present embodiments to the full extent indicated by the plain meaning of the terms in which the appended claims are expressed.

What is claimed is:

1. A liquid crystal display (LCD) device comprising:
a backlight module for providing light;
an LCD panel stacked on the backlight module, the LCD panel comprising a color filter substrate, a thin film transistor (TFT) substrate opposite to the color filter substrate, a liquid crystal layer between the color filter substrate and the TFT substrate, and a lower polarizer on a side of the TFT substrate away from the liquid crystal layer, the lower polarizer being adjacent to the backlight module;
the backlight module defining a camera hole, the camera hole extending through the lower polarizer;
wherein the camera hole comprises a bottom wall and a sidewall coupling to the bottom wall; the bottom wall is defined and formed by the TFT substrate; an adhesive layer is formed in a coupling region of the bottom wall and the sidewall to block light from the backlight module to leak.

2. The LCD device of claim 1, wherein a portion of the color filter substrate aligning with the camera hole is transparent; a portion of the TFT substrate aligning with the camera hole is transparent.

3. The LCD device of claim 1, wherein the LCD panel further comprises an upper polarizer on a side of the color filter substrate away from the liquid crystal layer, the upper polarizer defines a through hole extending through the upper polarizer and aligning with the camera hole.

4. The LCD device of claim 1, wherein the backlight module comprises a back plate; the back plate is substantially flat and bends to extend toward the LCD panel, and the back plate defines and forms the sidewall.

5. The LCD device of claim 4, wherein the adhesive layer extends along a peripheral portion of the bottom wall to form a ring shape; the adhesive layer partially covers the TFT substrate and the back plate.

6. The LCD device of claim 4, wherein the backlight module further comprises a reflection sheet stacked on the back plate, a light guide plate stacked on the reflection sheet, and an optical film group stacked on the light guide plate, wherein the optical film group is adjacent to the LCD panel; the back plate is on a side of the reflection sheet away from the LCD panel; the camera hole extends through the reflection sheet, the light guide plate, and the optical film group.

7. The LCD device of claim 4, wherein the back plate is not in direct with the TFT substrate.

8. The LCD device of claim 7, wherein a light shielding layer is on a surface of the transparent substrate adjacent to the backlight module; the light shielding layer extends around a circumference of the bottom wall to form a ring shape.

9. The LCD device of claim 8, wherein the light shielding layer fills a gap between the back plate and the TFT substrate.

10. The LCD device of claim 8, wherein a projection of the light shielding layer along a normal direction of the transparent substrate on the transparent substrate completely covers a projection of the adhesive layer along a normal direction of the transparent substrate on the transparent substrate.

11. The LCD device of claim 8, wherein the light shielding layer extends beyond the bottom wall on the surface of the transparent substrate.
